(19) United States
(12) Patent Application Publication
(10) Pub. No.: US 2012/0169758 A1
(43) Pub. Date: Jul. 5, 2012

(54) APPARATUS AND METHOD FOR PROVIDING THREE-DIMENSIONAL INTERFACE

(75) Inventors: Young Wook KIM, Seoul (KR); Man Ho SEOK, Goyang-si (KR); Kwi Yong CHO, Seoul (KR)

(73) Assignee: PANTECH CO., LTD., Seoul (KR)

(21) Appl. No.: 13/332,075

(22) Filed: Dec. 20, 2011

(30) Foreign Application Priority Data
Dec. 30, 2010 (KR) 10-2010-0138509

(51) Int. Cl. G09G 5/02; G09G 5/00

(52) U.S. Cl. 345/593; 345/156

(57) ABSTRACT

An apparatus to provide a three-dimensional (3D) interface and a method for providing a 3D interface are provided. The apparatus may output an interface space in a specific color using additive color mixtures of light, may sense a change in location of an object in the interface space, may sense the location change of the object as a motion, and may process an input corresponding to the sensed motion if the input corresponding to the sensed motion exists. The interface space may be a space in which the recognition areas of sensors overlap.

### CROSS-REFERENCE TO RELATED APPLICATION

This application claims priority from and the benefit under 35 U.S.C. §119(a) of Korean Patent Application No. 10-2010-0138509, filed on Dec. 30, 2010, which is hereby incorporated by reference for all purposes as if fully set forth herein.

### BACKGROUND

1. Field

The following description relates to an apparatus including an apparatus and a method for sensing a motion in a 3-dimensional (3D) space.

2. Discussion of the Background

With the rapid development of a 3-dimensional (3D) display, there is a demand for a 3D input method. To meet the demand, there is a move towards development of input devices for implementing an operation without directly touching a window; this trend may have many benefits including in the implementation for a 3D interface, control of a 3D image, development of a 3D game industry, and the like.

A conventional method for implementing a touch operation mainly uses a direct contact with a window (in the x, y axis). For construction of a 3D motion, various input methods have been devised using a capacitive sensing technology, a 3D remote controller, a 3D camera, and the like. However, capacitive sensing technology has a limited operation region due to the sensitivity of a sensor, a limited height along the z-axis, and the like.

Also, an input method using a device, such as a 3D remote controller, a 3D camera, a 3D infrared module, and the like, is difficult to incorporate in mobile equipment due to a complex structure, difficulty in minimizing the device, and the like.

### SUMMARY

Exemplary embodiments of the present invention provide an apparatus and method for providing a 3-dimensional (3D) interface.

Exemplary embodiments of the present invention also provide an apparatus and method for sensing a motion in a 3D space.

Exemplary embodiments of the present invention also provide an apparatus and method for forming an interface space in a 3D space and to sense a motion in the interface space.

Exemplary embodiments of the present invention also provide an apparatus and method for forming an interface space recognizable to a user in a 3D space using additive color mixtures of light, and for sensing a motion in the interface space.

Additional features of the invention will be set forth in the description which follows, and in part will be apparent from the description, or may be learned by practice of the invention.

An exemplary embodiment of the present invention discloses an apparatus including a sensor unit including at least three sensors to sense a distance, a motion sensing unit to sense a change in location of an object in an interface space and to sense the location change of the object as a motion, and an interface unit to determine if an input corresponding to the sensed motion exists and to process the input corresponding to the sensed motion.

Another exemplary embodiment of the present invention discloses a method for providing a 3D interface, the method including determining a location of an object in an interface space if the object is sensed in the interface space, sensing a change in the location of the object and sensing the location change of the object as a motion, determining whether an input corresponding to the sensed motion exists, and processing the input corresponding to the sensed motion if the input corresponding to the sensed motion exists.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating an apparatus according to an exemplary embodiment of the present invention.

FIG. 2 is a flowchart illustrating a method according to an exemplary embodiment of the present invention.

FIG. 3 is a flowchart illustrating a method according to an exemplary embodiment of the present invention.

FIG. 4 is a view illustrating recognition areas of sensors according to an exemplary embodiment of the present invention.

FIG. 5 is a view illustrating an interface space according to an exemplary embodiment of the present invention.

FIG. 6 is a view illustrating a recognition area of a sensor according to an exemplary embodiment of the present invention.

FIG. 7 is a view illustrating an interface space according to an exemplary embodiment of the present invention.

FIG. 8 is a view illustrating estimation of a 3D location using three sensors according to an exemplary embodiment of the present invention.

FIG. 9 is a view illustrating estimation of a 3D location using four sensors according to an exemplary embodiment of the present invention.

FIG. 10 is a view illustrating an interface space determined from a specific portion of a region according to an exemplary embodiment of the present invention.

### DETAILED DESCRIPTION OF THE ILLUSTRATED EMBODIMENTS

Exemplary embodiments are described more fully hereinafter with reference to the accompanying drawings, in which embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

Further, it will be understood that for the purposes of this disclosure, “at least one of”, and similar language, will be interpreted to indicate any combination of the enumerated elements following the respective language, including combinations of multiples of the enumerated elements. For example, “at least one of X, Y, and Z” will be construed to indicate X only, Y only, Z only, or any combination of two or more items X, Y, and Z (e.g., XYZ, XZ, YZ).

Aspects of the present invention provide an apparatus to provide an interface space in a 3-dimensional (3D) space and to sense a motion in the interface space and method for forming an interface space in a 3-dimensional (3D) space and for sensing a motion in the interface space.

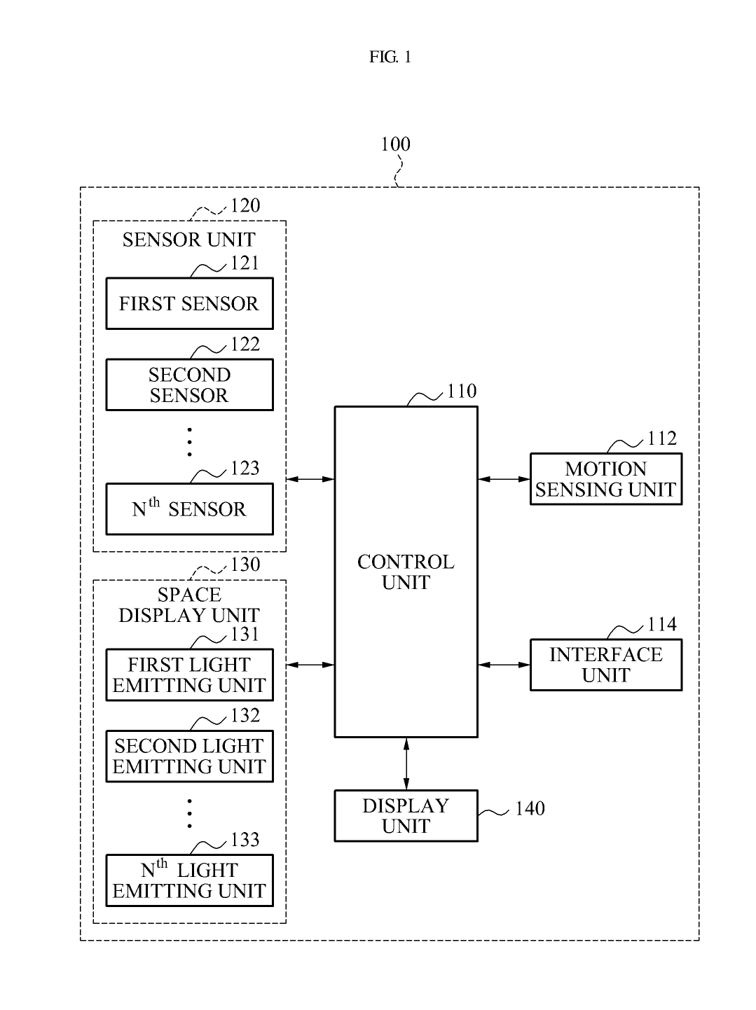

FIG. 1 is a block diagram illustrating an apparatus according to an exemplary embodiment of the present invention.

Referring to FIG. 1, the apparatus 100 may include a control unit 110, a sensor unit 120, a space display unit 130, a display unit 140, a motion sensing unit 112, and an interface unit 114.

The sensor unit 120 may include a first sensor 121, a second sensor 122, and additional sensors up to an Nth sensor 123 to sense a distance. In this instance, the sensors 121, 122, and 123 may have a specific orientation and a specific location to form a region in which is the recognition areas of the sensors 121, 122, and 123 all or partially overlap.

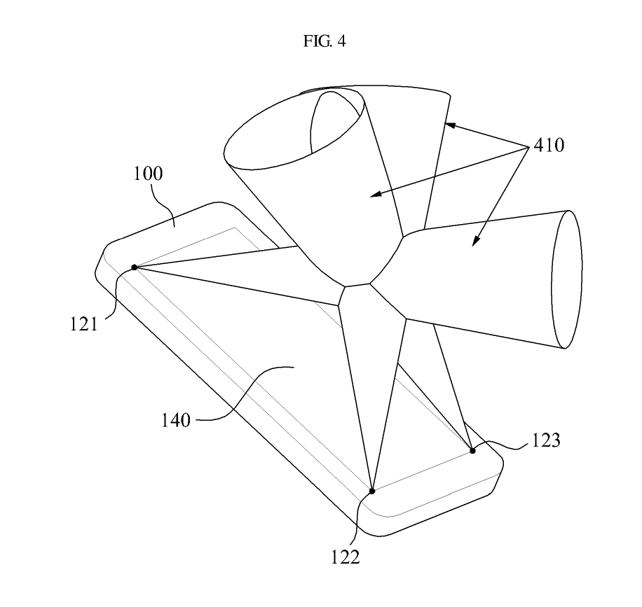

FIG. 4 is a view illustrating recognition areas of sensors according to an exemplary embodiment of the present invention.

Referring to FIG. 4, the sensors 121, 122, and 123 may each have a sensor angle between 20° and 60° above a portion or side, i.e., a display of the display unit 140, or the apparatus 100 and may form recognition areas 410. However, aspects need not be limited thereto such that the sensor angle may be less than 20° or greater than 60° above the display or the apparatus 100. Also, a region in which recognition areas of the sensors 121, 122, and 123 overlap may be formed at a specific distance from the display of the display unit 140 of the apparatus 100.

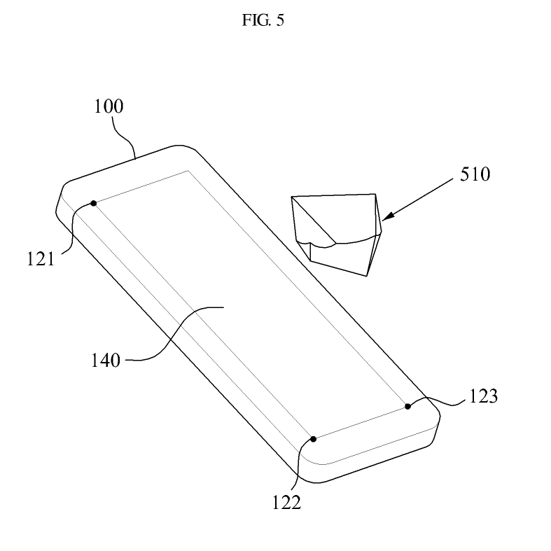

FIG. 5 is a view illustrating an interface space according to an exemplary embodiment of the present invention. In particular, FIG. 5 is a view illustrating an interface space 510, in which recognition areas of the sensors 121, 122, and 123 overlap.

Referring to FIG. 5, the interface space 510 may be a region in which recognition areas of the sensors 121, 122, and 123 of FIG. 4 overlap. The sensors 121, 122 and 123 may each have a sensor angle between 20° and 60° above the display of the display unit 140.

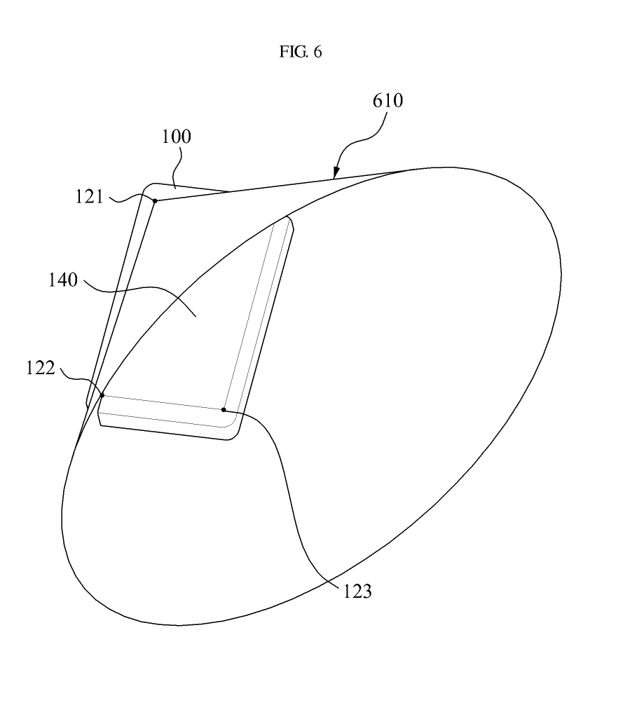

FIG. 6 is a view illustrating a recognition area of a sensor according to an exemplary embodiment of the present invention. In particular, FIG. 6 is a view illustrating a recognition area of a sensor 121, having a sensor angle of 90°.

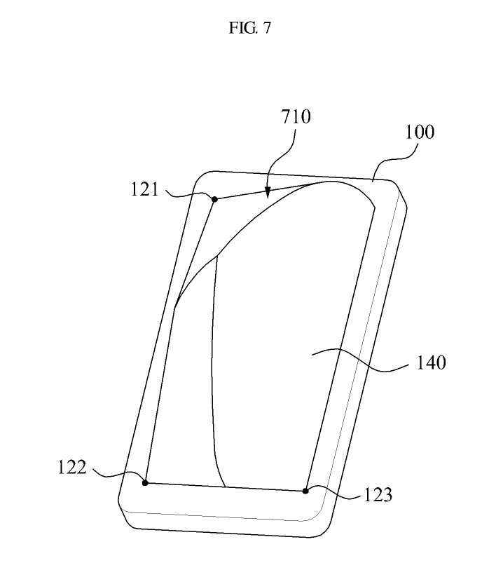

Referring to FIG. 6, if the sensor 121 has a sensor angle of 90° and is inclined at 45° relative to the display unit 140, a recognition area 610 may be formed as shown in FIG. 6. Also, if the three sensors, each having a sensor angle of 90°, are used, an interface space may be formed as shown in FIG. 7.

FIG. 7 is a view illustrating an interface space according to an exemplary embodiment of the present invention. In particular, FIG. 7 is a view illustrating an interface space 710, in which recognition areas of the sensors 121, 122, and 123 overlap and the recognition areas of the sensors 121, 122 and 123 each have a sensor angle of 90°.

Referring to FIG. 7, the interface space 710 may be a region in which recognition areas of the sensors 121, 122, and 123 of FIG. 4 overlap and the interface space 710 may include the entire display of the display unit 140. In other words, the interface space 710 projects from the entire surface of the display unit 140 of the apparatus 100.

Referring again to FIG. 1, the space display unit 130 may include a first light emitting unit 131, a second light emitting unit 132, and additional light emitting units up to an Nth light emitting unit 133 to each output a specific light. The space display unit 130 may output an interface space in a specific color using additive color mixtures of the specific lights outputted through the light emitting units 131, 132, and 133 to enable a user to recognize the s interface space. Although depicted with three light emitting units, the space display unit according to aspects of the present invention is not limited thereto and may have more than three light emitting units.

The display unit 140 may display any information that may occur during operation of the portable terminal, i.e., state information or an indicator, specific numbers and characters, a moving picture, a still picture, etc.

If an object is sensed in an interface space in which recognition areas of sensors overlap, the motion sensing unit 112 may sense a change in location of the object in the interface space and may sense the location change of the object as a motion.

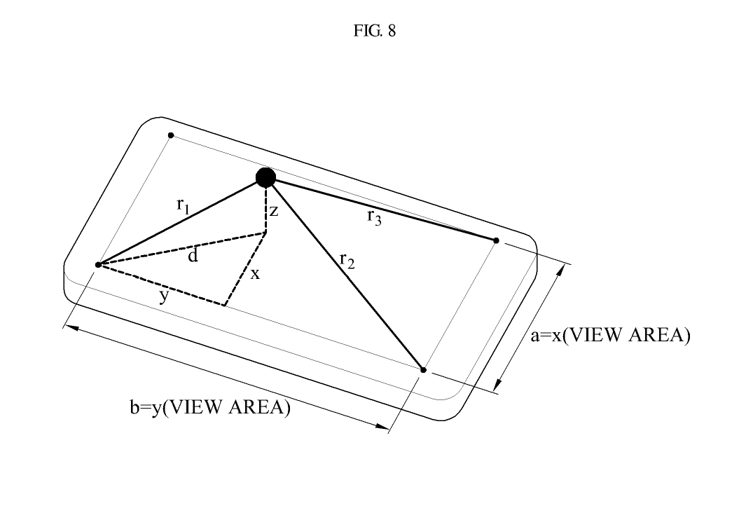

FIG. 8 is a view illustrating estimation of a 3D location using three sensors is according to an exemplary embodiment of the present invention.

A 3D location may be calculated using the following Equation 1 and the parameters of FIG. 8.

r₁=|\sqrt{x²+y²+z²}|

r₂=|\sqrt{x²+(b−y)²+z²}|

r₃=|\sqrt{(a−x)²+(b−y)²+z²}| Equation 1

where each of r₁, r₂, and r₃ is a distance from an object, measured by a sensor, ‘x’, ‘y’, and ‘z’ are coordinate values indicating a 3D location, ‘b’ is a vertical length of a view area, ‘a’ is a horizontal length of the view area, and d is the projection of r₁ on to the x-y plane. Although the Equation 2 includes absolute values, aspects of the present invention are not limited thereto and the absolute values may be omitted.

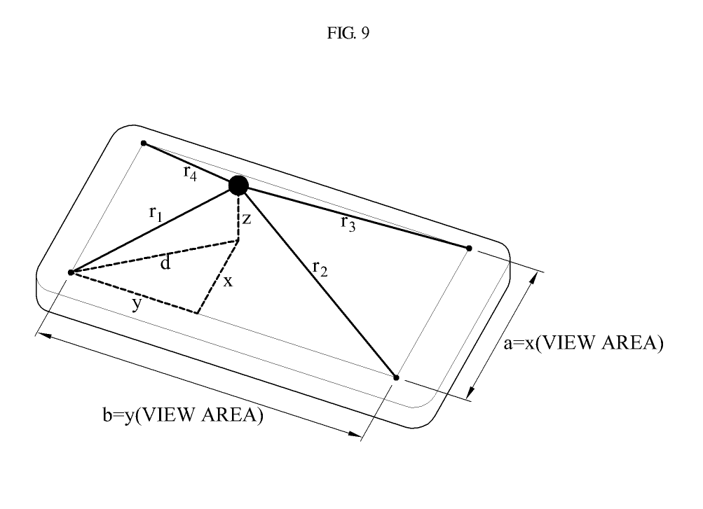

FIG. 9 is a view illustrating estimation of a 3D location using four sensors according to an exemplary embodiment of the present invention.

A 3D location may be calculated using the following Equation 2 and the parameters of FIG. 9.

r₁=|\sqrt{x²+y²+z²}|

r₂=|\sqrt{x²+(b−y)²+z²}|

r₃=|\sqrt{(a−x)²+(b−y)²+z²}|

r₄=|\sqrt{(a−x)²+y²+z²}| Equation 2

where each of r₁, r₂, r₃, and r₄ is a distance from an object, measured by a sensor, ‘x’, ‘y’, and ‘z’ are coordinate values indicating a 3D location, ‘b’ is a vertical length of a view area, and ‘a’ is a horizontal length of a view area, and d is the projection of r₁ on to the x-y plane. Although is the Equation 2 includes absolute values, aspects of the present invention are not limited thereto and the absolute values may be omitted.

In this instance, the interface space has an uneven and pointed recognition area in a z-axis. To provide a more user-friendly interface area, the interface space may be defined within a boundary condition represented by the following Equation 3:

x<a horizontal length of a view area, y<a vertical length of a view area, z<a z-axis of a specific height Equation 3

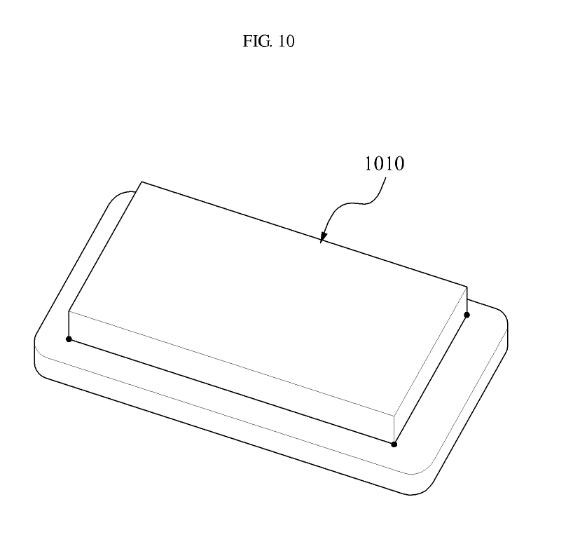

FIG. 10 is a view illustrating an interface space determined from a specific portion of a region according to an exemplary embodiment of the present invention. Referring to FIG. 1 and FIG. 10, the motion sensing unit 112 may sense a motion of an object in an interface space 1010 ranging to a specific vertical distance from the entire display of the portable terminal.

In particular, FIG. 10 is a view illustrating the interface area 1010 determined from a specific portion of a region, in which recognition areas of the sensors having a sensor angle of 90° overlap.

Referring again to FIG. 1, if the motion sensing unit 112 senses an object in an interface space, the motion sensing unit 112 may request the space display unit 130 change a display scheme of the interface space to indicate that an object was sensed.

The space display unit 130 may change the display scheme of the interface space in response to the request of the motion sensing unit 112. In this instance, the changing of the display scheme of the interface space may include at least one of changing a color of the interface space, changing brightness of the interface space, and flashing of the interface space.

The interface unit 114 may determine if an input corresponding to the sensed motion exists, and may process the input corresponding to the sensed motion.

Also, if an input corresponding to the sensed motion exists, the interface unit 114 may request the space display unit 130 to change the display scheme of the interface space to report that the input corresponding to the sensed motion was sensed. The space display unit 130 may change the display scheme of the interface space in response to the request of the motion sensing unit 112.

In this instance, the changing of the display scheme of the interface space may include at least one of changing a color of the interface space, changing brightness of the interface space, and flashing of the interface space.

Further, the changing of the display scheme of the interface space may include at least one of changing a color of the interface space to a color corresponding to the input, changing brightness of the interface space to brightness corresponding to the input, and flashing of the interface space with a type of light corresponding to the input.

The control unit 110 may control the entire operation of the 3D interface apparatus 100. Also, the control unit 110 may perform operations of the motion sensing unit 112 and the interface unit 114. Although operations of the control unit 110, the motion sensing unit 112, and the interface unit 114 are described herein for ease of description, aspects need not be limited thereto such that the operations of the respective units may be combined. Accordingly, the control 110 may include at least one processor configured to perform operations of the motion sensing unit 112 and the interface unit 114. Also, the control 110 may include at least one processor configured to perform a portion of the operations of the motion sensing unit 112 and the interface unit 114.

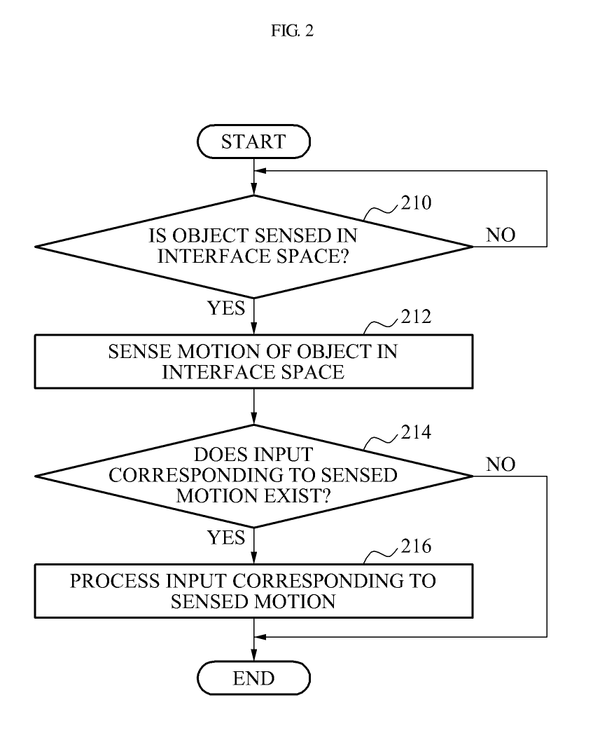

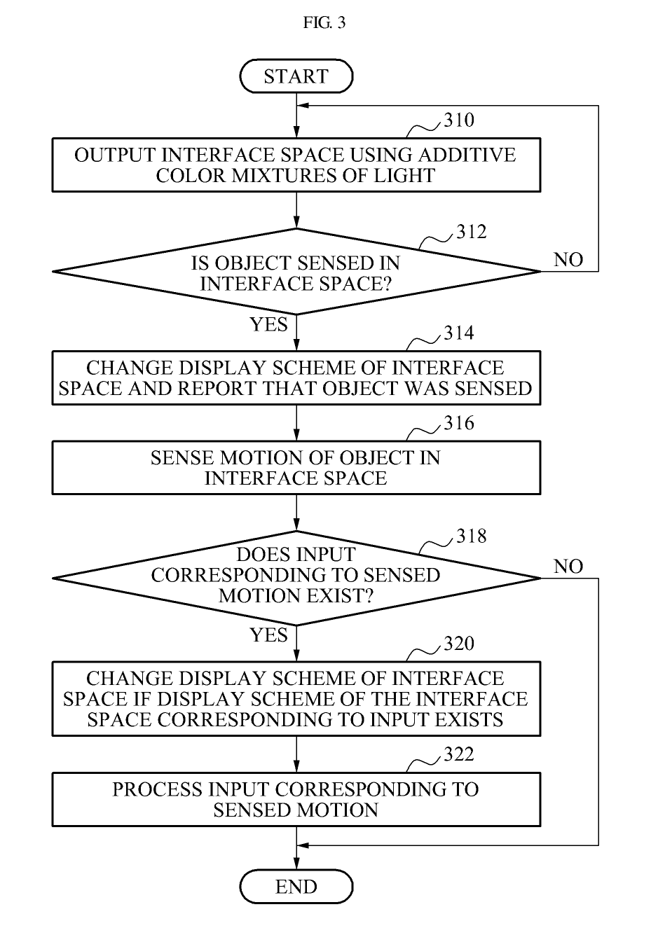

Hereinafter, a method for providing a 3D interface of the portable terminal according to an exemplary embodiment of the present invention is described below with reference to FIG. 2 and FIG. 3.

FIG. 2 is a flowchart illustrating method according to an exemplary embodiment of the present invention.

Referring to FIG. 2, in operation 210, the apparatus 100 determines if an object is sensed in an interface space in which recognition areas of sensors sensing a distance overlap. If an object is sensed in operation 210, the apparatus 100 may sense a change in location of the object in the interface space and may sense the location change of the object as a motion in interface space, in operation 212.

In operation 214, the apparatus 100 may determine if an input corresponding to the sensed motion exists. If an input corresponding to the sensed motion exists in operation 214, the apparatus 100 may process the input corresponding to the sensed motion, in operation 216. If an input corresponding to the sensed motion does not exist in operation 214, the process may end.

FIG. 3 is a flowchart illustrating a method for providing a 3D interface according to an exemplary embodiment of the present invention.

Referring to FIG. 3, in operation 310, the apparatus 100 may output an interface space in a specific color using additive color mixtures of light.

In operation 312, the apparatus 100 may determine if an object is sensed in the interface space in which recognition areas of sensors sensing a distance overlap.

If an object is not sensed in operation 312, the apparatus 100 may return to operation 310.

If an object is sensed in operation 312, the apparatus 100 may change a display scheme of the interface space to report that the object was sensed, in operation 314. In this instance, the changing of the display scheme of the interface space may include at least one of changing a color of the interface space, changing brightness of the interface space, and flashing of the interface space.

In operation 316, the apparatus 100 may sense a change in location of the object in the interface space, and may sense the location change of the object as a motion in interface space.

In operation 318, the apparatus 100 may determine if an input corresponding to the sensed motion exists. If an input corresponding to the sensed motion exists in operation 318, the apparatus 100 may change the display scheme of the interface space to inform that the input corresponding to the sensed motion was sensed, in operation 320. In this instance, the changing of the display scheme of the interface space may include at least one of changing a color of the interface space, changing brightness of the interface space, and flashing of the interface space. Further, the changing of the display scheme of the interface space may include at least one of changing a color of the interface space to a color corresponding to the input, changing brightness of the interface space to brightness corresponding to the input, and flashing of the interface space in a type corresponding to the input.

In operation 322, the apparatus 100 may process the input corresponding to the sensed motion.

According to exemplary embodiments of the present invention, an apparatus to provide and a method for providing a 3D interface space recognizable to a user, which may output an interface space in a specific color using additive color mixtures of light, may sense, as a motion, a change in location of an object in the interface space in which recognition areas of sensors sensing a distance overlap if the object is sensed in the interface space, and may process an input corresponding to the sensed motion if the input corresponding to the sensed motion exists.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of is the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus to provide a 3-dimensional (3D) interface, the apparatus comprising:
a sensor unit comprising at least three sensors to sense distances;
a motion sensing unit to sense a change in location of an object in an interface space, and to sense the location change of the object as a motion; and
an interface unit to determine if an input corresponding to the sensed motion exists and to process the input corresponding to the sensed motion.

2. The apparatus of claim 1, wherein the interface space is a region in which recognition areas of the sensors overlap.

3. The apparatus of claim 2, wherein the sensors of the sensor unit have a specific orientation and a specific location to form the region in which the recognition areas of the sensors overlap.

4. The apparatus of claim 2, further comprising:
a space display unit to output the interface space,
wherein the space display unit comprises light emitting units to output a specific light, and
wherein the interface space is in a specific color formed using additive color mixtures of the specific lights outputted by each of the light emitting units.

5. The apparatus of claim 4, wherein the space display unit outputs the interface space in a specific color by outputting a specific light to an area equal to the recognition area of each of the sensors using the light emitting units corresponding to the sensors.

6. The apparatus of claim 4, wherein, if the object is sensed in the interface space, the motion sensing unit requests the space display unit to change a display scheme of the interface space, and
the space display unit changes the display scheme of the interface space in response to the request of the motion sensing unit.

7. The apparatus of claim 6, wherein the changing of the display scheme of the interface space includes at least one of changing a color of the interface space, changing brightness of the interface space, and flashing of the interface space.

8. The apparatus of claim 4, wherein, if the input corresponding to the sensed motion exists, the interface unit requests the space display unit to change a display scheme of the interface space, and
the space display unit changes the display scheme of the interface space in response to the request of the motion sensing unit.

9. The apparatus of claim 8, wherein the changing of the display scheme of the interface space includes at least one of changing a color of the interface space, changing brightness of the interface space, and flashing of the interface space.

10. The apparatus of claim 8, wherein the changing of the display scheme of the interface space includes at least one of changing a color of the interface space to a color corresponding to the input, changing brightness of the interface space to brightness corresponding to the input, and flashing of the interface space in a type corresponding to the input.

11. The apparatus of claim 2, wherein the sensor unit comprises at least three sensors each having a sensor angle of 90° or more, and wherein the recognition areas of the three sensors overlap over a display of a portable terminal, and
wherein the motion sensing unit senses the motion of the object in the interface space to a specific vertical distance from the display of the portable terminal.

12. The apparatus of claim 2, wherein the region in which the recognition areas of the sensors of the sensor unit overlap is formed at a specific distance from a display of a display unit.

13. A method for providing a three-dimensional (3D) interface, the method comprising:
determining a location of an object in an interface space if the object is sensed in the interface space;
sensing a change in the location of the object and determining the location change of the object as a motion;
determining whether an input corresponding to the sensed motion exists; and
processing the input corresponding to the sensed motion if the input corresponding to the sensed motion exists.

14. The method of claim 13, wherein the interface space is a region in which recognition areas of sensors sensing a distance overlap.

15. The method of claim 14, further comprising:
outputting the interface space in a specific color using additive color mixtures of light.

16. The method of claim 15, wherein the outputting of the interface space comprises outputting a specific light for each of the sensors to an area equal to the recognition area of each of the sensors.

17. The method of claim 14, further comprising:
changing a display scheme of the interface space, if the object is sensed in the interface space.

18. The method of claim 17, wherein the changing of the display scheme of the interface space includes at least one of changing a color of the interface space, changing brightness of the interface space, and flashing of the interface space if the object is sensed in the interface space.

19. The method of claim 14, further comprising:
changing a display scheme of the interface if the input corresponding to the sensed motion exists.

20. The method of claim 19, wherein the changing of the display scheme of the interface space includes at least one of changing a color of the interface space, changing brightness of the interface space, and flashing of the interface space.

21. The method of claim 19, wherein the changing of the display scheme of the interface space includes at least one of changing a color of the interface space to a color corresponding to the input, changing brightness of the interface space to brightness corresponding to the input, and flashing of the interface space in a type corresponding to the input if the input corresponding to the sensed motion exists.

22. The method of claim 14, wherein the region in which the recognition areas of the sensors overlap and includes a display of a portable terminal, and
wherein the interface space is the region from the display of the portable terminal to a specific vertical distance from the display of the portable terminal.

23. The method of claim 14, wherein the interface space is a region formed at a specific distance from the surface of a display unit of a portable terminal.
